(19) United States
(12) Patent Application Publication
(10) Pub. No.: US 2015/0100428 A1
(43) Pub. Date: Apr. 9, 2015

(54) CONTAINER WITH USER LINK

(71) Applicant: Rehrig Pacific Company, Los Angeles, CA (US)

(72) Inventor: Kaley R. Parkinson, Jr., Danville, CA (US)

(21) Appl. No.: 14/505,953

(22) Filed: Oct. 3, 2014

Related U.S. Application Data
(60) Provisional application No. 62/012,106, filed on Jun. 13, 2014.
(60) Provisional application No. 61/886,280, filed on Oct. 3, 2013.

(51) Int. Cl. G06Q 10/08; G06Q 10/00; G06Q 30/02

(52) U.S. Cl. CPC G06Q 10/087; G06Q 30/0267; G06Q 10/30
USPC 705/14.64; 705/28

(57) ABSTRACT

A container tracking system includes a plurality of containers each having a user link, such as an RFID or NFC chip or optical code, such as a barcode or QR code. The user link is activatable by a user's mobile device. A server is configured to be accessed by the user's mobile device upon activation of the user link. The server provides information to the user's mobile device in response to activation of the user link. The server may log the location of the user's mobile device at the time of activation in order to log the location of the container.

### BACKGROUND

There are many contexts in which numerous reusable containers are shipped to different locations, such as from a distribution facility to stores and returned to the distribution facility for reuse. For example beverage crates may be loaded with beverage containers at a distribution facility and then shipped to stores. At the stores, store employees and/or customers select and remove beverage containers from the crates. The empty crates are returned to the distribution facility for reuse.

In another context, waste containers (trash, recyclying, yard waste, etc) may be distributed by a municipality or waste collection company to the residents of a geographic area. In some areas, the containers have chips or barcodes that uniquely identify the particular container. Each container is identified and associated with a particular address in the geographic area. The chips or barcodes may be read during waste pickup. This facilitates evaluation and optimization of pickup routes because the time and location of each pickup can be evaluated.

### SUMMARY

A container tracking system includes a plurality of containers each having a user link, such as an RFID or NFC chip or optical code, such as a barcode or QR code. The user link is activatable by a user's mobile device. A server is configured to be accessed by the user's mobile device upon activation of the user link. The server provides information to the user's mobile device in response to activation of the user link. The server may log the location of the user's mobile device at the time of activation in order to log the location (and optionally, date and time at that location) of the container.

The container tracking system may include a first server and a second server. The first server is first accessed by the user's mobile device upon activation of the user link. The first server may be configured to redirect the user's mobile device to the second server to provide information to the user's mobile device. The first server may be configured to receive a container identification of each particular container of the plurality of containers and to redirect the user's mobile device to the second server based upon the container identification. For example, the first server may be configured to redirect the user's mobile device to a third server based upon the container identification.

Some or all of the plurality of containers may be beverage crates. Some or all of the plurality of containers may be waste containers. The user link may be an RFID chip, an optical code, an NFC chip.

The information provided to the mobile device may include a promotion or advertisement and the information may be based upon the particular container on which the user link was activated. The information provided to the user's mobile device may be based upon the location information received by the server.

In the case where the containers are waste containers, the information provided could include a waste pickup schedule.

In a method of tracking a plurality of containers according to one embodiment of the present invention, each of a plurality of containers are associated with a unique container identification. Each of the plurality of containers is associated with a unique user link. When, one of the container identifications is received from a user's mobile device, the user's mobile device is provided information based upon the container identification. The location may be received from the user's mobile device and used to log the location of the associated container.

### BRIEF DESCRIPTION OF THE DRAWINGS

FIG. 1 shows a first example implementation of the present invention for use with a beverage crate.

FIG. 2 is an example schematic for servers that could be used to implement the present invention.

FIG. 3 shows a second example implementation for use with a waste container.

FIG. 4 shows an example screen for display on a mobile device for use with some implementations the present invention.

### DETAILED DESCRIPTION OF A PREFERRED EMBODIMENT

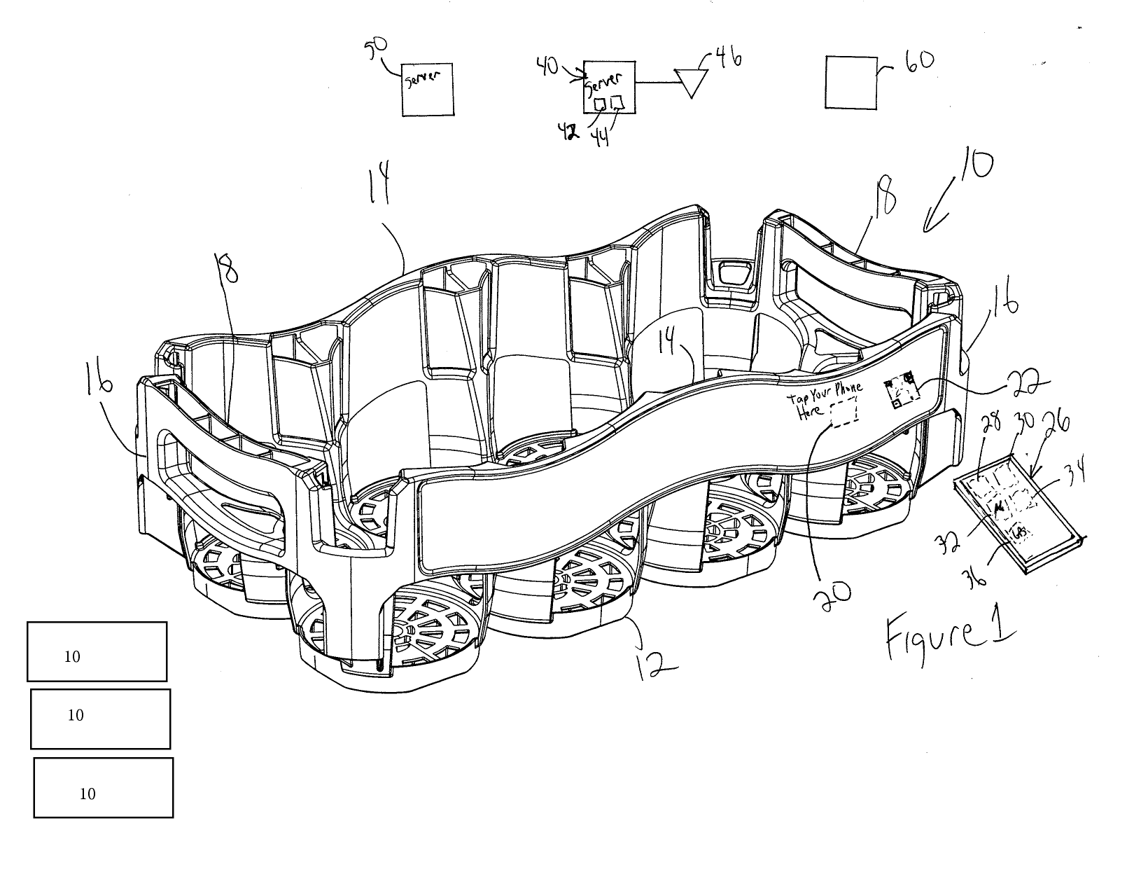

A first embodiment of the present invention relates to a crate 10 or other container for providing products to consumers in stores. The crate 10 shown as an example in FIG. 1 is for carrying bottles, particularly plastic beverage bottles, such as multi-serving (e.g. 2 liter) bottles. The crate 10 is preferably injection molded as a single piece of plastic, such as HDPE or other suitable material. As is known, the crate 10 is one of thousands of crates 10 that would be used by a distribution facility to deliver beverage containers (or other items) to stores.

The example crate 10 includes a base 12, a pair of side walls 14 extending upward from side edges of the base 12, and end walls 16 extending upward from end edges of the base 12. Handles 18 may be formed in the end walls 16.

The crate 10 includes at least one smartphone-readable user link, such as an NFC or RFID chip 20 and/or a QR code 22. In the example shown, the chip 20 and code 22 are placed on the sidewall 14, but other locations on the crate 10 are also possible. Other types of links and other protocols could also be used. The links uniquely identify each crate 10 (e.g. like a serial number).

A user mobile device or smartphone 26 includes hardware for reading one or more of the links on the crate 10, including an NFC reader 28 and/or a camera 30 for reading the QR code 22. The smartphone 26 further includes a processor 32 with suitable electronic storage and programming for performing the functions described herein. The smartphone 26 further includes one or more wireless communication circuits 34 such as wifi, Bluetooth, cell-data, GSM, CDMA, etc. The smartphone 26 may also include a GPS receiver 36 or other location-determining hardware.

A server 40 (which could include more than one physical and/or virtual server) includes a processor 42 and electronic storage and is suitably programmed to perform the functions described herein. The server 40 receives communications from a plurality of smartphones such as smartphone 26, for example, via a cell tower 46 (or wireless access point) and via a network, such as the internet. The server 40 may selectively pass connections from smartphones 26 to a second server 50 or the server 40 may act as an intermediary between the smartphones 26 and the second server 50.

A second server 50 provides a web page and/or data over a wide-area network (such as the internet) to a smartphone app (which could be a web browser or a dedicated app). The data may relate to the product being sold in the container, such as coupons, games, contests, promotional videos, etc. The second server 50 may be operated by a manufacturer, distributor or licensor of the products in the crate 10.

The server 40 may be accessible by one or more computers 60 for monitoring the data collected on the server 40 and/or the data collected on server 50. The computers 60 provide access to the manufacturer, distributor or licensor.

In use, thousands of crates 10 are loaded with beverage containers for sale to consumers. In this particular example, the containers that would be loaded into this crate 10 would be 2-liter soft drink bottles. The crates 10 are loaded with filled bottles, stacked and shipped in trucks to stores. The loaded crates 10 are often stacked and displayed in the store so that customers can select a bottle and remove it from the crate 10 for purchase.

In the store, a user can place his smartphone 26 near the chip 20 or use the camera 30 to read the QR Code. This directs the smartphone 26 over the wireless communication circuit 34 to connect (e.g. via the internet) to the server 40. The server 40 obtains user session data from the smartphone 26 and redirects the smartphone 26 to the second server 50.

The user session data received by the server 40 may include some or all of the following:

TABLE 1
User Session Data Capture Record Details

QR Station Code Fields

QR Station ID Code
QR Link URL

Geolocation Fields

GPS Geolocation
(Boolean)
[true if GPS sensor
used, false if IP address
Geolocation used]
Latitude
Longitude
Country
State
County
City
Zip Code

User Details Fields

Visitor IP Address
Locale Language Code
Locale Country Code
Web Browser
Web Browser Version
OS Name
OS Version
Device Name
Device Version
Screen Resolution

QR Station Code Fields

QR Station ID Code Field:

Capture this by using url parameters. Each
group of QR station links to the same site but
has a URL perimeter that needs to be passed
through to the database.
Example:
http://qrdemo.com/program1?QRIDCODE=001
would be saved as: 001
http://qrdemo.com/program1?QRIDCODE=002
would be saved as: 002
http://qrdemo.com/program1?QRIDCODE=003
would be saved as: 003
http://qrdemo.com/program1?QRIDCODE=004
would be saved as: 004

QR Link URL:

Capture the url of the link.
Example:
http://qrdemo.com/program1?QRIDCODE=001
would be saved as:
http://qrdemo.com/program1
http://qrdemo.com/program1?QRIDCODE=002
would be saved as
http://qrdemo.com/program1
http://qrdemo.com/program2?QRIDCODE=003
would be saved as
http://qrdemo.com/program2
http://qrdemo.com/program2?QRIDCODE=004
would be saved as
http://qrdemo.com/program2

User Details Fields

Can use several available methods such as
https://github.com/codejoust/session.js.

The server 40 obtains the unique identification of that crate 10 that was read by the user. The server 40 also obtains the location (from smartphone gps or Geolocation features). With just this information, a sampling of the locations over time of the inventory of thousands of crates 10 is provided by the server 40. This provides the server 40 with the ability to provide asset management and tracking if desired. The server 40 can determine if crates 10 are in locations that they were not expected to be. For example, the server 40 can determine if the crates 10 are in stores that they are not supposed to be in, which may indicate that the producer (e.g. the bottler) is shipping outside the bottler's assigned geographic area. The server 40 can determine if the crates 10 are in locations other than stores (e.g. possibly stolen). The server 40 also gathers data indicating how often the links are accessed.

The server 40 may then connect the smartphone 26 to the server 50 for access to webpages or access via smartphone apps to data on the server 50. The server 50 receives some or all of the user session data from server 40. The server 50 may selectively present data (e.g. webpage or other data) based upon the user session data. For example, the server 50 may select the data to present to the smartphone 26 based upon the location of the smartphone 26 (e.g. based upon city, state, region or country, or depending upon the particular store where the smartphone 26 accessed the link).

For example, the server 50 may immediately present a particular coupon to the smartphone 26 based upon the location of the smartphone 26 within a particular store (e.g. within a particular grocery store chain), so that the user could use the coupon to purchase the product in the crate 10 or a product associated with the product in the crate 10. For example, the server 50 may deliver a coupon (or offer or promotion) to a loyalty app (such as a grocery store loyalty app) on the user's mobile device. That coupon may be for the product in the container 10, or may be for a companion or related product. For example, if the container 10 contains hot dog buns, the server 50 could tell the user through the loyalty app on the user's mobile device, via a coupon or information about a promotion, that the user can receive a discount if those hot dog buns were purchased with certain hot dogs also available in the store. The user can then use that coupon or promotion at the checkout on that visit by using their loyalty app for that store.

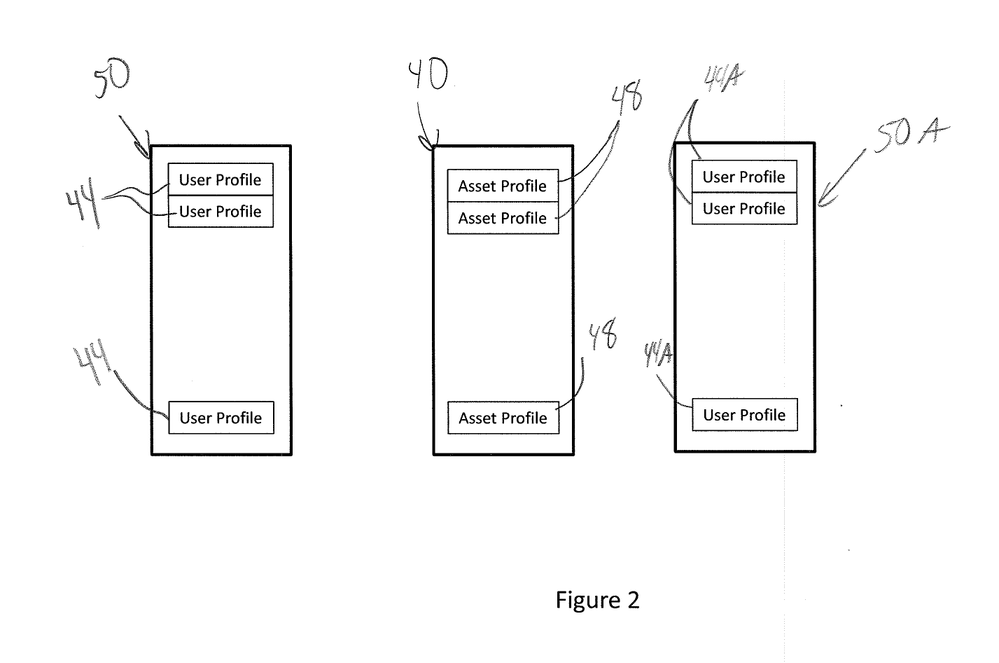

The smartphone 26 may have an app or web account that automatically logs the user into a personalized account or user profile on the server 50. As shown schematically in FIG. 2, the server 50 may store a plurality of user profiles 44. Each user profile 44 may contain more information about the user (e.g. age, income level, location of residence, etc) that is useful to the manufacturer (or supplier or retailer) in combination with the evidence that the particular user is encountering the manufacturer's product at a particular location or store at a particular date and time.

Again referring to FIG. 2, the server 40 may optionally include a record or asset profile 48 of each of the assets, such as each crate 10. Again, each crate 10 may be individually identifiable by the user link. Each asset profile 48 contains a record of every location and time/date that the crate 10 has been linked by a user's mobile device.

The server 40 may be programmed to redirect the user's mobile device 26 to the server 50 based upon the identification of the particular container 10 received by the server 40 from the user's mobile device 26. For example, the server 40 may be configured to track containers 10 for a plurality of distributors of beverage crates and/or distributors (or manufacturers) of other types of containers. Depending upon the container identification received by the server 40, the server 40 may redirect the user's mobile device 26 to a third server 50A, associated with a different distributor or manufacturer, optionally with its own user profiles 44A. The third server 50A may provide different information, different ads, and track a different set of users.

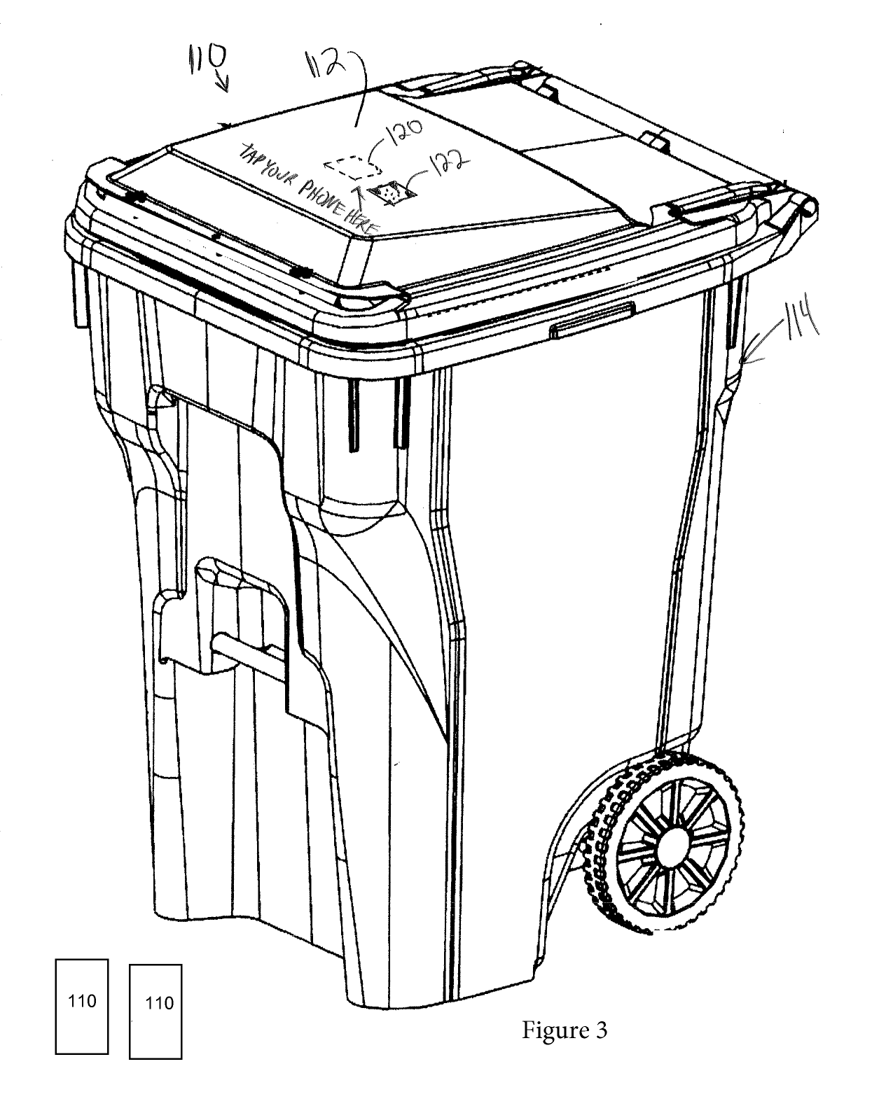

Another embodiment of a container 110 according to the present invention is shown in FIG. 3. In FIG. 3, the container 110 is a roll out cart 110 for recyclables, organic waste, trash, etc, which could be of the type that homeowners can roll out to the curb for pickup. The roll out cart 110 may have a lid 112 pivotably connected to a cart body 114. The cart body 114 includes a base with side walls extending upward from the base.

The roll out cart 110 includes at least one smartphone-readable link, such as an NFC RFID chip 120 and/or a QR code 122 (as in the first embodiment). In the example shown, the chip 120 is embedded (e.g. insert-molded) or attached to the lid 112, but other locations on the roll out cart 110 are also possible. The QR code 122 may be displayed on top of the lid 112 as shown, or in another location on the cart 110. Other types of links and other protocols could also be used. As above, the links uniquely identify each roll out cart 110 (e.g. like a serial number).

The roll out carts 110 are distributed by the homeowner's city and/or collection company. During distribution, the roll out carts 110 are specifically assigned to the address of each property owner (homeowner, business, etc), i.e. to the address where it will be picked up each week. As is known, the collection vehicle may read the link (120 or 122) when it collects material from that cart 110 (or a different, additional chip or code could be used). Each link (NFC RFID chip 120 and/or QR code 122 or other link) is unique and is associated in the server 40 (FIGS. 1 and 2) with the property address at which the cart 110 is located.

As in the first embodiment, when a user activates the link with their smartphone 26, the smartphone 26 automatically connects to the server 40 over the network. The server 40 identifies the particular link (chip 120 or code 122) and the address or property owner to which the cart 110 is associated (in asset profile 48). The server 40 also logs the information available to it such as in Table 1 above, including the current location of the cart 110 (via the smartphone 26 gps, for example). The date/time and location of the cart 110 is logged in the asset profile 48.

The server 40 may display ads or promotions on the smartphone 26 and then redirect the smartphone 26 to the server 50, which could be operated by the city or the collection company. For example, the server 50 may provide information (such as on a webpage) to the smartphone 26 regarding collection times (which may be particular to the address associated with the cart 110), holiday schedules, information regarding what materials are recyclable, community events, ads, etc.

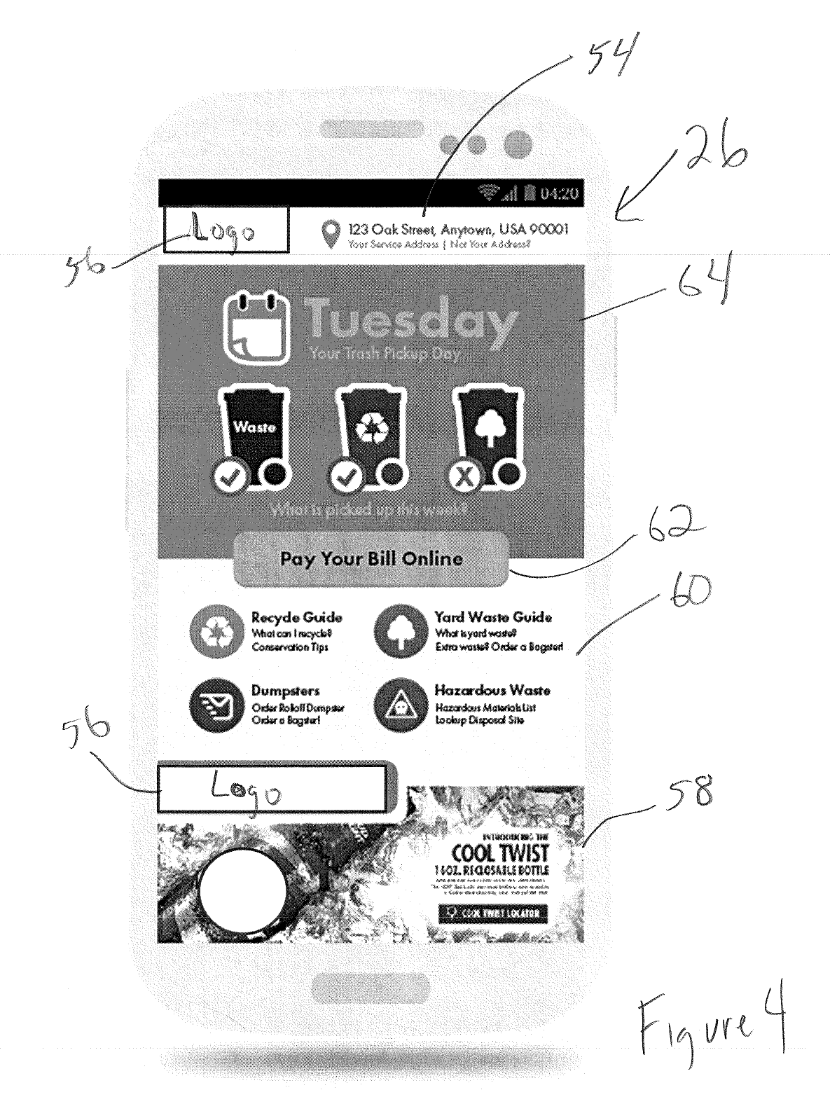

FIG. 4 shows an example screen to be displayed on a user's smartphone 26 after activating one of the user links 120, 122 on the cart 110. The screen displays the address 54 to which the particular cart 110 is assigned. One or more logo fields 56 are displayed, such as for displaying the logos of the collection company, the municipality, etc. An ad 58 (which itself may contain a link to the sponsor's webpage) may be displayed. Information links 60, such as links to information regarding recycling, yard waste, dumpsters and hazardous waste, may be provided on the screen. A bill payment link 62 may be provided on the screen. Collection information 64 may be displayed on the screen, including which day of the week (or next date) is trash pickup day and what types of collections (i.e. waste, recycling, yard waste, etc) will occur on the next collection date.

Other containers, such as collapsible containers or bins, or pallets could also be used in conjunction with the present invention. Many different types of products could be loaded in the containers, such as beverage containers (bottles, cans), bakery goods (loaves of bread, buns, muffins), dairy, meats, and non-food products such as lubricants or other items in containers, etc.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A container tracking system comprising:
a plurality of containers each having a user link activatable by a user's mobile device;
a server configured to be accessed by the user's mobile device upon activation of the user link, the server configured to provide information to the user's mobile device.

2. The container tracking system of claim 1 wherein the server is configured to receive location information from the user mobile device when one of the user links is activated.

3. The container tracking system of claim 2 wherein the server is configured to log the location information and associate the location information with the particular container on which the user link was activated.

4. The container tracking system of claim 1 wherein the server is a second server and further including a first server first accessed by the user's mobile device upon activation of the user link, and wherein the first server is configured to redirect the user's mobile device to the second server to provide information to the user's mobile device.

5. The container tracking system of claim 4 wherein the first server is configured to receive a container identification of each particular container of the plurality of containers and to redirect the user's mobile device to the second server based upon the container identification.

6. The container tracking system of claim 5 wherein the first server is configured to redirect the user's mobile device to a third server based upon the container identification.

7. The container tracking system of claim 1 wherein the plurality of containers are beverage crates.

8. The container tracking system of claim 1 wherein the user link is an RFID chip.

9. The container tracking system of claim 1 wherein the user link is an optical code.

10. The container tracking system of claim 1 wherein the user link is an NFC chip.

11. The container tracking system of claim 10 wherein the plurality of containers are beverage crates.

12. The container tracking system of claim 1 wherein the plurality of containers are waste containers.

13. The container tracking system of claim 1 wherein the information includes a promotion.

14. The container tracking system of claim 1 wherein the information includes an advertisement.

15. The container tracking system of claim 1 wherein the information provided to the user's mobile device is based upon an identification of the particular container on which the user link was activated.

16. The container tracking system of claim 15 wherein the server is configured to receive location information from the user mobile device when one of the user links is activated, wherein the information provided to the user's mobile device is based upon the location information received by the server.

17. The container tracking system of claim 1 wherein the plurality of containers are waste containers and wherein the information provided includes a waste pickup schedule.

18. A method of tracking a plurality of containers including the steps of:
associating each of a plurality of containers with a container identification, each of the container identifications being unique;
associating each of the plurality of containers with a user link, each of the user links being unique;
receiving one of the container identifications from a user's mobile device; and
providing information to the user's mobile device based upon the one of the container identifications.

19. The method of claim 18 further including the step of receiving a location from the user's mobile device.

20. The method of claim 19 further including the step of logging the location and the one of the container identifications.

21. The method of claim 18 further including the steps of loading the plurality of containers with products and delivering the loaded containers to a store, wherein the step of receiving one of the container identifications is from the user's mobile device at the store, and further including the step of receiving the plurality of containers empty and then reloading the plurality of containers with products and delivering the reloaded containers to the store.

22. A method of tracking a plurality of containers including the steps of:
associating each of a plurality of containers with a container identification, each of the container identifications being unique;
associating each of the plurality of containers with a user link, each of the user links being unique;
receiving one of the container identifications from a user's mobile device;
receiving a location from the user's mobile device; and
logging the location and the one of the container identifications.
